(19) United States
(12) Patent Application Publication
(10) Pub. No.: US 2025/0298464 A1
(43) Pub. Date: Sep. 25, 2025

(54) POST-PROCESSING FOR SUBSAMPLED FOVEATED RENDERING FRAME REGIONS

(71) Applicant: ADVANCAED MICRO DEVICES, INC., Santa Clara, CA (US)

(72) Inventors: William Herz, Santa Clara, CA (US); Frank Christopher Azor, Orlando, FL (US)

(21) Appl. No.: 18/612,036

(22) Filed: Mar. 21, 2024

(51) Int. Cl. G06F 3/01; G06T 1/20

(52) U.S. Cl. CPC G06F 3/013; G06T 1/20

(57) ABSTRACT

A processing system assigns pixels of each frame of the video stream to one or more regions to be subsampled for foveated rendering. The processing system renders the frame based on the assigned regions and subsampling characteristics for each region. To minimize artifacts of the subsampled regions, the processing system post-processes the frame based on the subsampling characteristics of each region. With prior knowledge of the location of each respective region and the subsampling characteristics assigned to each region, either an accelerated processing unit or a discrete graphics processing unit of the processing system applies a post-processing filter to each region or to one or more of the borders between the regions. The post-processing filters blend adjacent regions having subsampling characteristics different from each other to minimize discontinuities between regions.

### BACKGROUND

Some processing systems apply foveated rendering techniques to images to render different regions of an image (or frame of a video or video game) at different levels of resolution. Such techniques take advantage of limitations in human vision, which has high acuity in only a small central region. A processing system utilizing foveated rendering renders at a higher resolution a location in an image at which a user's gaze is likely to be focused (or at which the user's gaze is focused, based on gaze tracking that measures the eye's position and movement), and renders at a lower resolution locations in the image at which the user's gaze is less likely to be focused. For example, the center of an image, or an area of the image that includes a human face, may be rendered at a higher resolution, and the periphery of the image may be rendered at a lower resolution. Foveated rendering allows a processing system to conserve or reallocate computational resources without noticeably detracting from the image quality.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system for post-processing foveated rendered frames in accordance with some embodiments.

FIG. 2 is a block diagram of an example graphics pipeline in accordance with some embodiments

FIG. 3 is a diagram illustrating multiple regions of a frame having different subsampling characteristics in accordance with some embodiments.

FIG. 4 is a block diagram of a processing system selectively tasking an accelerated processing unit or a discrete graphics processing unit with post-processing a foveated rendered frame in accordance with some embodiments.

FIG. 5 is a flow diagram illustrating a method for post-processing foveated rendered frames in accordance with some embodiments.

### DETAILED DESCRIPTION

A frame that is rendered using foveated rendering techniques typically includes multiple regions, each of which is rendered at a different resolution. For example, a central region of the frame is typically rendered at a highest resolution, while an adjacent, more peripheral region is rendered at a lower resolution, and a region at the edges of the frame is rendered at an even lower resolution. In some cases, the multiple regions of the frame for purposes of foveated rendering are concentric circles or ovals. To render each region at a different resolution, a processing system subsamples regions that are not fully rendered (e.g., all but the foveal region) by leaving pixels or sub-pixels unrendered as “holes” that may be “filled in” using techniques of varying complexity. Each subsampled region has subsampling characteristics such as the degree to which pixels are left unrendered and a direction (e.g., vertical or horizontal) in which pixels are left unrendered. For example, a first subsampled region may render 50% of pixels by leaving unrendered every other pixel in a horizontal direction (or in a vertical direction). Another subsampled region may render 25% of pixels by leaving unrendered every other pixel in both the horizontal and vertical directions.

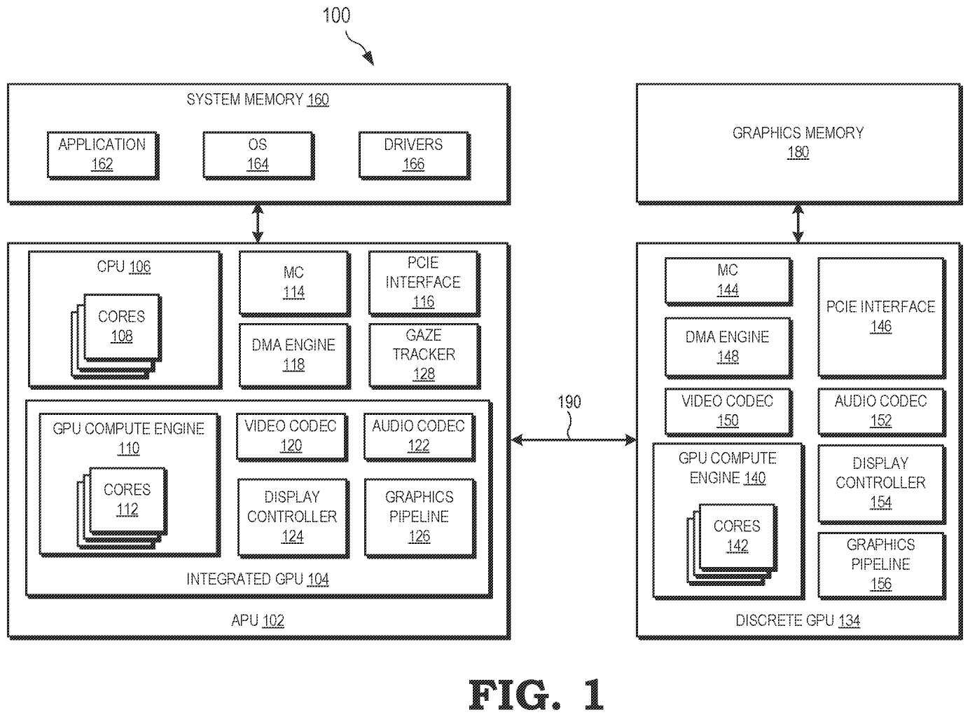

Artifacts are potentially visible at the borders between regions having different subsampling characteristics, particularly in cases where there is some latency in the frame rate of a video or video game coupled with a rapid shift in a user's gaze to a different region of the frame. To minimize artifacts of subsampled regions, FIGS. 1-5 illustrate techniques for post-processing subsampled regions of a frame. In some implementations, a processing system includes a parallel processor that is dedicated to graphics processing (a discrete graphics processing unit, or dGPU) and one or more accelerated processing units (APUs). An APU refers to any cooperating collection of hardware and/or software that performs those functions and computations associated with accelerating graphics processing tasks, data parallel tasks, or nested data parallel tasks in an accelerated manner compared to conventional central processing units (CPUs), software and/or combinations thereof. For example, an APU is a processing unit (e.g., processing chip/device) that can function both as a CPU and a GPU. Moreover, an APU is a chip that includes additional processing capabilities used to accelerate one or more types of computations outside of a general-purpose CPU. In one implementation, an APU can include a general-purpose CPU integrated on a same die with a GPU, a FPGA, machine learning processors, digital signal processors (DSPs), and audio/sound processors, or other processing unit, thus improving data transfer rates between these units while reducing power consumption. In some implementations, an APU can include video processing and other application-specific accelerators. A GPU is a graphics and video rendering device for computers, workstations, game consoles, and similar digital processing devices. A dGPU is generally implemented as a co-processor component to the CPU of the computer and can be provided in the form of an add-in card (e.g., video card), co-processor, or as functionality that is integrated directly into the motherboard of the computer or into other devices.

In some implementations, the APU performs gaze tracking to track the gaze of a user of a video game or other application. Based on the gaze tracking and/or other metrics of frames of a video stream for the video game or other application, the APU assigns pixels of each frame of the video stream to one or more regions to be subsampled for foveated rendering and communicates the assigned regions and subsampling characteristics for each region to the dGPU. The dGPU renders the frame based on the assigned regions and subsampling characteristics for each region. By not fully rendering the subsampled regions of the frame, the dGPU can increase the frame rate of the video game or other application, thus improving the user experience.

To minimize artifacts of the subsampled regions, the processing system post-processes the frame based on the subsampling characteristics of each region. With prior knowledge of the location of each respective region and the subsampling characteristics assigned to each region, the processing system applies a post-processing filter to each region or to one or more of the borders between the regions. The post-processing filters blend adjacent regions having subsampling characteristics different from each other to minimize discontinuities between regions. Consequently, the transitions from one subsampled region to the next are less visible. The processing system selects the post-processing filter applied to each region according to the subsampling characteristics of the region. For example, in some embodiments, the processing system applies a first filter to a first subsampled region in which 50% of pixels are left unrendered by rendering only every other pixel in a horizontal direction and applies a second filter to a second subsampled region in which 50% of pixels are left unrendered by rendering only every other pixel in a vertical direction. The processing system applies a third filter to a third subsampled region in which 75% of pixels are left unrendered by rendering every other pixel in both the horizontal and vertical directions. In some implementations, the filtering applied by the processing system to the subsampled regions or to the transitions between subsampled regions includes edge enhancement, upscaling, machine learning-based upscaling, or super resolution. The processing system further bases the filtering on tracking a gaze of a viewer of the frame in some implementations. For example, in some implementations, the processing system post-processes a location of the frame in response to an eye tracker detecting movement of the viewer's eye toward the location.

In some implementations, the dGPU performs post-processing of the subsampled regions of the frame based on the locations of the regions and the subsampling characteristics of each region. However, performing post-processing at the dGPU could negatively impact the frame rate, potentially to an extent that negates the performance benefits of foveated rendering of the frame. Accordingly, in some implementations, the processing system includes profiling circuitry that predicts an impact of performing post-processing of the frame at the dGPU on the frame rate of the video stream. If the impact is below a threshold, the processing system tasks the dGPU with post-processing. However, if the impact is at or above the threshold, the processing system tasks the APU with post-processing so the dGPU can continue rendering tasks without sacrificing processing cycles for post-processing. By adaptively distributing post-processing between the APU and the dGPU, the processing system minimizes visual artifacts from subsampling while maintaining a high frame rate.

FIG. 1 illustrates a processing system 100 for post-processing foveated rendered frames in accordance with some implementations. The processing system 100 of FIG. 1 can be implemented in a computing device such as a laptop or desktop personal computer, a server, a mobile device such as a smart phone or tablet, a gaming console, and so on. The processing system 100 includes two or more parallel processors (e.g., vector processors, graphics processing units (GPUs), general-purpose GPUs (GPGPUs), non-scalar processors, highly-parallel processors, artificial intelligence (AI) processors, inference engines, machine learning processors, tensor processors, neural processors, compute processors, other processors that include SIMD or SIMT or similar architectures, other multithreaded processing units, and the like). FIG. 1 illustrates an example of a parallel processor, and in particular GPUs 104, 134, in accordance with some embodiments. It will be appreciated by those of skill in the art that other systems can include more GPUs, or can use other types of accelerated processing devices, without departing from the spirit of the present disclosure.

In the example of FIG. 1, the processing system 100 includes an APU 102 that integrates an CPU 106 and a GPU 104 (referred to herein as an “integrated GPU”). The CPU 106 and the integrated GPU 104 can be implemented on the same chip and thus can share a number of components and interfaces such as system memory 160, one or more memory controllers 114 and one or more direct memory addressing (DMA) engines 118 for accessing system memory 160, an eye tracker 128 to track movement of a user's eyes and determine a center of gaze for each eye in real-time, bus interfaces such as a personal computing interface express (PCIe) interface 116, and other interfaces and adapters not depicted in FIG. 1 such as a network interface, universal serial bus (USB) interface, persistent storage interface such as hard disk drive (HDD) and solid state drive (SSD) interface, and so on. The CPU 106 includes one or more cores 108 (i.e., execution engines), cache structures (not shown), pipeline components (also not shown), and so on. The CPU 106 and other shared components are connected to the GPU 104 via a high-speed on-chip communications fabric (not shown). The cores 108 execute instructions such as program code for an application 162 stored in the system memory 160 and the CPU 106 stores information in the system memory 160 such as the results of the executed instructions. The CPU 106 is also able to initiate graphics processing by issuing draw calls to the integrated GPU 104. Some implementations of the CPU 106 implement multiple processor cores (not shown in FIG. 1 in the interest of clarity) that execute instructions concurrently or in parallel.

In the example system 100 of FIG. 1, the integrated GPU 104 includes a GPU compute engine 110 that includes multiple single instruction multiple data (SIMD) processing cores 112 having many parallel processing units (not shown) configured to perform one or more operations for one or more instructions received by the GPU compute engine 110. The SIMD processing cores 112 perform the same operation on different data sets to produce one or more results. For example, GPU compute engine 110 includes one or more SIMD processor cores 112 each including compute units that include one or more SIMD units to perform operations for one or more instructions from a graphics pipeline 126. To facilitate the performance of operations by the compute units, GPU compute engine 110 includes one or more command processors (not shown). Such command processors, for example, include circuitry configured to execute one or more instructions from a graphics pipeline 126 by providing data indicating one or more operations, operands, instructions, variables, register files, or any combination thereof to one or more compute units necessary for, helpful for, or aiding in the performance of one or more operations for the instructions.

The GPU compute engine 110 also includes other components not depicted in FIG. 1 such as geometry processors, rasterizers, graphic command processors, hardware schedulers, asynchronous compute engines, caches, data shares, and so on. In the example of FIG. 1, the integrated GPU 104 also includes hardware accelerators in the form of application specific integrated circuits or functional logic blocks such as a video encoder/decoder 120 (i.e., a “codec”) for accelerated video encoding and decoding, an audio codec 122 for accelerated audio encoding and decoding, a display controller 124 for accelerated display processing, and a graphics pipeline 126.

In the example of FIG. 1, the APU 102 communicates with a discrete GPU 134 (dGPU) over an interconnect such as a PCIe interconnect 190. The PCIe interface 116 of the APU 102 and a PCIe interface 146 of the dGPU 134 communicate over the PCIe interconnect 190. In some examples, the APU 102 and the dGPU 134 can be implemented on the same substrate (e.g., a printed circuit board). In other examples, the dGPU 134 is implemented on video or graphics card that is separate from the substrate of the APU 102.

Like the integrated GPU 104, the dGPU 134 in the example of FIG. 1 includes a GPU execution engine 140 (e.g., “GPU compute engine”) that includes multiple SIMD processing cores 142 having many parallel processing units (not shown) configured to perform one or more operations for one or more instructions received by the GPU compute engine 140. The SIMD processing cores 142 perform the same operation on different data sets to produce one or more results. For example, GPU compute engine 140 includes one or more SIMD processor cores 142 each including compute units that include one or more SIMD units to perform operations for one or more instructions from a graphics pipeline 156. To facilitate the performance of operations by the compute units, GPU compute engine 140 includes one or more command processors (not shown). Such command processors, for example, include circuitry configured to execute one or more instructions from a graphics pipeline 156 by providing data indicating one or more operations, operands, instructions, variables, register files, or any combination thereof to one or more compute units necessary for, helpful for, or aiding in the performance of one or more operations for the instructions.

The GPU compute engine 140 also includes other components not depicted in FIG. 1 such as geometry processors, rasterizers, graphic command processors, hardware schedulers, asynchronous compute engines, caches, data shares, and so on. In the example of FIG. 1, the dGPU 134 also includes hardware accelerators in the form of application specific integrated circuits or functional logic blocks such as a video codec 150 for accelerated video encoding and decoding, an audio codec 152 for accelerated audio encoding and decoding, and a display controller 154 for accelerated display processing. The dGPU 134 also includes one or more memory controllers 144 and one or more DMA engines 148 for accessing graphics memory 180 (e.g., a local memory). In some examples, the memory controllers 144 and DMA engines 148 are configured to access a shared portion of system memory 160.

In the example system 100 of FIG. 1, the system memory 160 (e.g., dynamic random access memory (DRAM)) hosts an operating system 164 that interfaces with device drivers 166 for the processor resources (i.e., the APU and discrete GPU and their constituent components) described above. The system memory 160 also hosts one or more applications 162. Pertinent to this disclosure, the one or more applications 162 can be video game applications, graphics applications, multimedia applications, video editing applications, video conferencing applications, high performance computing applications, machine learning applications, or other applications that take advantage of the parallel nature and/or graphics and video capabilities of the integrated GPU 104 and the dGPU 134. The one or more applications 162 generate workloads (e.g., graphics rendering workloads, audio/video transposing workloads, media playback workloads, machine learning workloads, etc.) that are allocated to the integrated GPU 104 or the discrete GPU (or a combination of both) by a call to the operating system 164. Readers of skill in the art will appreciate that the one or more applications can be a variety of additional application types generating a variety of workload types, not all of which are identified here. However, the specific mention of application types and workload types within the present disclosure should not be construed as limiting application types and workload types to those that are identified here.

In some implementations, the APU 102 tracks the gaze direction of a user's eyes (or receives gaze tracking information from the dGPU 134, the CPU 106, a gaze tracking sensor, or other component) and determines a foveal region of a frame at which the user's gaze is focused based on the gaze tracking information. For example, in some implementations, the APU 102 receives gaze information from a sensor from which the APU 102 derives the gaze direction. The APU 102 divides the frame into a plurality of regions for foveated rendering and assigns subsampling characteristics for each region. For example, in some implementations, the APU 102 assigns each pixel of the frame to one of a plurality of regions and assigns subsampling characteristics such as the percentage of pixels within each region that is to be left unrendered and the direction of unrendered pixels (e.g., every other pixel in a horizontal/vertical direction). In some implementations, the APU 102 sends the assigned regions and subsampling characteristics for each region as metadata with the frame to the dGPU 134.

The dGPU 134 receives the frame and assigned regions and subsampling characteristics of each region and renders the frame according to the assigned regions and subsampling characteristics. In some implementations, if post-processing the frame based on the assigned regions and subsampling characteristics to minimize visible artifacts at, e.g., the boundaries between regions having different subsampling characteristics, can be performed by the dGPU 134 without negatively impacting the frame rate, the dGPU 134 post-processes the frame by, e.g., applying to each subsampled region a filter matched to the subsampling characteristics of the region based on information received from the APU 102 regarding the assigned regions and subsampling characteristics. The filters perform post-processing such as edge enhancement, upscaling, machine learning-based upscaling, or super resolution to blend transitions between adjacent subsampled regions having different subsampling characteristics.

In some implementations, if post-processing the frame at the dGPU 134 would negatively impact the frame rate beyond a threshold amount, the processing system 100 tasks the APU 102 with post-processing the frame. In such implementations, the APU 102 applies post-processing filters matched to each subsampled region based on the assigned regions and subsampling characteristics of each assigned region in parallel with the dGPU 134 performing rendering tasks. Thus, the APU 102 minimizes perceptual subsampled graphics artifacts in the frame without using processing cycles of the dGPU 134. Accordingly, the frame rate of the video stream is unaffected by post-processing of the frame.

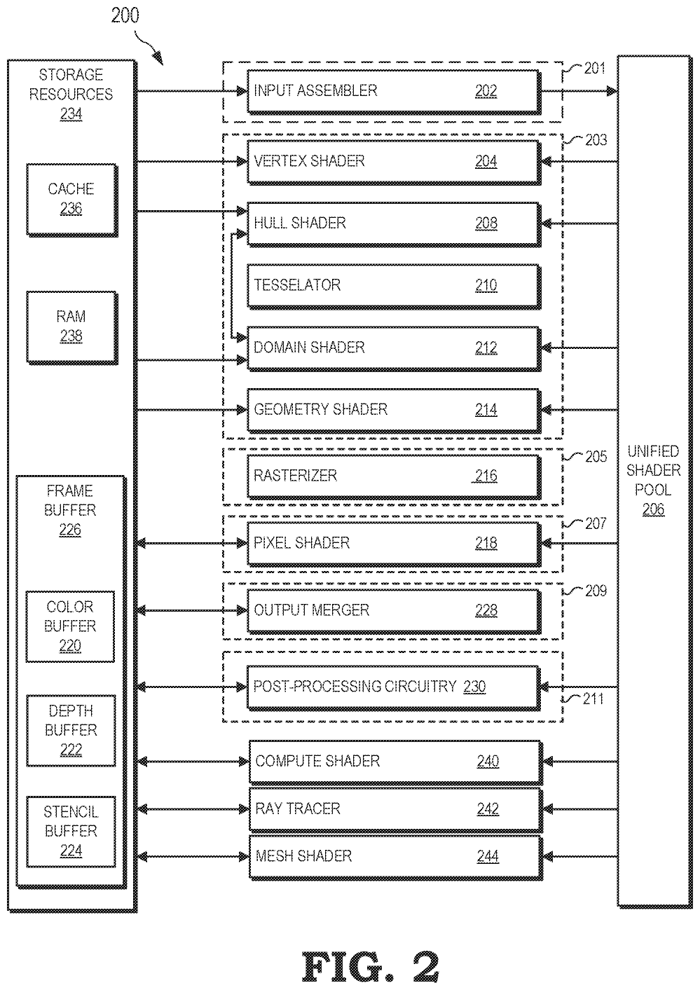

Referring now to FIG. 2, a block diagram of an example graphics pipeline 200 is presented, in accordance with some embodiments. In some embodiments, example graphics pipeline 200 is implemented in processing system 100 as graphics pipelines 126, 156. Example graphics pipeline 200 is configured to render graphics objects as images that depict a scene which has three-dimensional geometry in virtual space (also referred to herein as “screen space”), but potentially a two-dimensional geometry. Example graphics pipeline 200 typically receives a representation of a three-dimensional scene, processes the representation, and outputs a two-dimensional raster image. Various stages of example graphics pipeline 200 process data that is initially properties at end points (or vertices) of a geometric primitive, where the primitive provides information on an object being rendered. Typical primitives in three-dimensional graphics include triangles and lines, where the vertices of these geometric primitives provide information on, for example, x-y-z coordinates, texture, and reflectivity.

According to some embodiments, example graphics pipeline 200 has access to storage resources 234 (also referred to herein as “storage components”). Storage resources 234 include, for example, a hierarchy of one or more memories or caches that are used to implement buffers and store vertex data, texture data, and the like for example graphics pipeline 200. In some embodiments, storage resources 234 are implemented within the processing system 100 using respective portions of system memory 160. In some embodiments, storage resources 234 include or otherwise have access to one or more caches 236, one or more random access memory (RAM) units 238, video random access memory unit(s) (not pictured for clarity), one or more processor registers (not pictured for clarity), and the like, depending on the nature of data at the particular stage of example graphics pipeline 200. Accordingly, it is understood that storage resources 234 refer to any processor-accessible memory utilized in the implementation of example graphics pipeline 200.

Example graphics pipeline 200, for example, includes stages that each perform respective functionalities. For example, these stages represent subdivisions of functionality of example graphics pipeline 200. Each stage is implemented partially or fully as shader programs executed by either the integrated GPU 104 or the dGPU 134. According to embodiments, stages 201 and 203 of example graphics pipeline 200 represent the front-end geometry processing portion of example graphics pipeline 200 prior to rasterization. Stages 203 to 211 represent the back-end pixel processing portion of example graphics pipeline 200.

During input assembler stage 201 of example graphics pipeline 200, an input assembler 202 is configured to access information from the storage resources 234 that is used to define objects that represent portions of a model of a scene. For example, in various embodiments, the input assembler 202 includes circuitry configured to read primitive data (e.g., points, lines and/or triangles) from user-filled buffers (e.g., buffers filled at the request of software executed by the processing system 100, such as an application 162) and assembles the data into primitives that will be used by other pipeline stages of the example graphics pipeline 200. The application 162 provides shader code and three-dimensional objects for rendering to example graphics pipeline 200. In some embodiments, the input assembler 202 is configured to assemble vertices into several different primitive types (e.g., line lists, triangle strips, primitives with adjacency) based on the primitive data included in the buffers and formats the assembled primitives for use by the rest of example graphics pipeline 200.

According to some embodiments, example graphics pipeline 200 operates on one or more virtual objects defined by a set of vertices set up in the screen space and having geometry that is defined with respect to coordinates in the scene. For example, the input data utilized in example graphics pipeline 200 includes a polygon mesh model of the scene geometry whose vertices correspond to the primitives processed in the rendering pipeline in accordance with aspects of the present disclosure, and the initial vertex geometry is set up in the storage resources 234 during an application stage implemented by, for example, CPU 106.

During the vertex processing stage 203 of example graphics pipeline 200, one or more vertex shaders 204 are configured to process vertices of the primitives assembled by the input assembler 202. For example, a vertex shader 204 includes circuitry configured to first receive a single vertex of a primitive as an input and outputs a single vertex. The vertex shader 204 then performs various per-vertex operations such as transformations, skinning, morphing, per-vertex lighting, or any combination thereof, to name a few. Transformation operations include various operations to transform the coordinates (e.g., X-Y coordinate, Z-depth values) of the vertices. These operations include, for example, one or more modeling transformations, viewing transformations, projection transformations, perspective division, viewport transformations, or any combination thereof. Herein, such transformations are considered to modify the coordinates or “position” of the vertices on which the transforms are performed. Other operations of the vertex shader 204 modify attributes other than the coordinates.

In some embodiments, one or more vertex shaders 204 are implemented partially or fully as vertex shader programs to be executed on one or more processor cores 112, 142 (e.g., one or more processor cores 112, 142 operating as compute units). Some embodiments of shaders such as the vertex shader 204 implement massive single-instruction-multiple-data (SIMD) processing so that multiple vertices are processed concurrently. In at least some embodiments, example graphics pipeline 200 implements a unified shader model so that all the shaders included in example graphics pipeline 200 have the same execution platform on the shared massive SIMD units of the processor cores 112, 142. In such embodiments, the shaders, including one or more vertex shaders 204, are implemented using a common set of resources that is referred to herein as the unified shader pool 206.

During the vertex processing stage 203, in some embodiments, one or more vertex shaders 204 perform additional vertex processing computations that subdivide primitives and generate new vertices and new geometries in the screen space. These additional vertex processing computations, for example, are performed by one or more of a hull shader 208, a tessellator 210, a domain shader 212, and a geometry shader 214. The hull shader 208, for example, includes circuitry configured to operate on input high-order patches or control points that are used to define the input patches. Additionally, the hull shader 208 outputs tessellation factors and other patch data. According to some embodiments, within example graphics pipeline 200, primitives generated by the hull shader 208 are provided to the tessellator 210. The tessellator 210 includes circuitry configured to receive objects (such as patches) from the hull shader 208 and generate information identifying primitives corresponding to the input objects, for example, by tessellating the input objects based on tessellation factors provided to the tessellator 210 by the hull shader 208. Tessellation, as an example, subdivides input higher-order primitives such as patches into a set of lower-order output primitives that represent finer levels of detail (e.g., as indicated by tessellation factors that specify the granularity of the primitives produced by the tessellation process). As such, a model of a scene is represented by a smaller number of higher-order primitives (e.g., to save memory or bandwidth) and additional details are added by tessellating the higher-order primitive.

The domain shader 212 includes circuitry configured to receive a domain location, other patch data, or both as inputs. The domain shader 212 is configured to operate on the provided information and generate a single vertex for output based on the input domain location and other information. The geometry shader 214 includes circuitry configured to receive a primitive as an input and generate up to four primitives based on the input primitive. In some embodiments, the geometry shader 214 retrieves vertex data from storage resources 234 and generates new graphics primitives, such as lines and triangles, from the vertex data in storage resources 234. In particular, the geometry shader 214 retrieves vertex data for a primitive and generates one or more primitives. To this end, for example, the geometry shader 214 is configured to operate on a triangle primitive with three vertices. A variety of different types of operations can be performed by the geometry shader 214, including operations such as point sprint expansion, dynamic particle system operations, fur-fin generation, shadow volume generation, single pass render-to-cubemap, per-primitive material swapping, per-primitive material setup, or any combination thereof. According to some embodiments, the hull shader 208, the domain shader 212, the geometry shader 214, or any combination thereof are implemented as shader programs to be executed on the processor cores 112, 142, whereas the tessellator 210, for example, is implemented by fixed-function hardware.

Once front-end processing (e.g., stages 201, 203) of example graphics pipeline 200 is complete, the scene is defined by a set of vertices which each have a set of vertex parameter values stored in the storage resources 234. In certain implementations, the vertex parameter values output from the vertex processing stage 203 includes positions defined with different homogeneous coordinates for different zones.

As described above, stages 205 to 211 represent the back-end processing of example graphics pipeline 200. The rasterizer stage 205 includes a rasterizer 216 having circuitry configured to accept and rasterize simple primitives that are generated upstream. The rasterizer 216 is configured to perform shading operations and other operations such as clipping, perspective dividing, scissoring, viewport selection, and the like. In embodiments, the rasterizer 216 is configured to generate a set of pixels that are subsequently processed in the pixel processing/shader stage 207 of the example graphics processing pipeline. In some implementations, the set of pixels includes one or more tiles. In some embodiments, the rasterizer 216 is implemented by fixed-function hardware.

The pixel processing stage 207 of example graphics pipeline 200 includes one or more pixel shaders 218 that include circuitry configured to receive a pixel flow (e.g., the set of pixels generated by the rasterizer 216) as an input and output another pixel flow based on the input pixel flow. To this end, a pixel shader 218 is configured to calculate pixel values for screen pixels based on the primitives generated upstream and the results of rasterization. In embodiments, the pixel shader 218 is configured to apply textures from a texture memory, which, according to some embodiments, is implemented as part of the storage resources 234. The pixel values generated by one or more pixel shaders 218 include, for example, color values, depth values, and stencil values, and are stored in one or more corresponding buffers, for example, a color buffer 220, a depth buffer 222, and a stencil buffer 224, respectively. The combination of the color buffer 220, the depth buffer 222, the stencil buffer 224, or any combination thereof is referred to as a frame buffer 226. In some embodiments, example graphics pipeline 200 implements multiple frame buffers 226 including front buffers, back buffers and intermediate buffers such as render targets, frame buffer objects, and the like. Operations for the pixel shader 218 are performed by a shader program that executes on the processor cores 112, 142.

According to embodiments, the pixel shader 218, or another shader, accesses shader data, such as texture data, stored in the storage resources 234. Such texture data defines textures which represent bitmap images used at various points in example graphics pipeline 200. For example, the pixel shader 218 is configured to apply textures to pixels to improve apparent rendering complexity (e.g., to provide a more “photorealistic” look) without increasing the number of vertices to be rendered. In another instance, the vertex shader 204 uses texture data to modify primitives to increase complexity, by, for example, creating or modifying vertices for improved aesthetics. AS an example, the vertex shader 204 uses a height map stored in storage resources 234 to modify displacement of vertices. This type of technique can be used, for example, to generate more realistic-looking water as compared with textures only being used in the pixel processing stage 207, by modifying the position and number of vertices used to render the water. The geometry shader 214, in some embodiments, also accesses texture data from the storage resources 234.

Within example graphics pipeline 200, the output merger stage 209 includes an output merger 228 accepting outputs from the pixel processing stage 207 and merges these outputs. As an example, in embodiments, output merger 228 includes circuitry configured to perform operations such as z-testing, alpha blending, stenciling, or any combination thereof on the pixel values of each pixel received from the pixel shader 218 to determine the final color for a screen pixel. For example, the output merger 228 combines various types of data (e.g., pixel values, depth values, stencil information) with the contents of the color buffer 220, depth buffer 222 and, in some embodiments, the stencil buffer 224 and stores the combined output back into the frame buffer 226. The output of the output merger stage 209 can be referred to as rendered pixels that collectively form a rendered frame (not shown). In one or more implementations, the output merger 228 is implemented by fixed-function hardware.

It is typically desirable to display rendered graphics at a frame rate (e.g., 60, 90, 120 frames per second) and resolution that are high enough to provide a convincingly immersive experience for the user. Transmitting rendered graphics at such frame rates and/or resolutions presents a challenge for the limits of the latency and maximum bit rate of the transmission medium. Accordingly, various techniques are employed to reduce the latency and/or bit rate of the transmission while having no effect, or an acceptably low effect, on the resolution and frame rate of the rendered graphics as perceived by the user.

The human visual system perceives maximum detail only in the very center of the visual field, and perceives less detail moving out from the center toward the periphery of the field. The reduced detail at the periphery is typically not consciously perceived, as the brain “fills in” the missing detail based on inference, earlier observations of that portion of the scene, and other factors. Accordingly, an image of a scene need only include maximum detail of the scene in areas of the image to which the center of the viewer's visual field is directed in order to appear fully detailed to the viewer. Correspondingly less detail is required for portions of the image further away from these areas.

By rendering only a foveal region of a frame at full resolution and rendering non-foveal regions of the frame at lower resolution, the example graphics pipeline 200 reduces the amount of data required to transmit rendered graphics to achieve a desired fidelity as perceived by the user. Portions of the frame falling within the paracentral, near-peripheral, mid-peripheral, and far peripheral areas of the user's field of view can be transmitted at correspondingly lower fidelity with less impact on the overall fidelity of the image as perceived by the user. Encoding rendered graphics (or other image information) based on the expected location of the center of the viewer's field of view in this way is referred to as foveated rendering. In some implementations, reducing the resolution of part or all of an image has the advantage of reducing resource requirements for processing, transmitting, and/or displaying the image (e.g., reduced computing power, bandwidth, screen resolution, latency, or other requirements). By reducing resolution in peripheral regions of an image, as opposed to (or to a greater degree than) in central regions of an image, resource requirement reductions can be achieved with little or no perceptual difference to the human visual system in some implementations.

In some embodiments, example graphics pipeline 200 includes a post-processing stage 211 implemented after the output merger stage 209. During the post-processing stage 211, post-processing circuitry 230 operates on the rendered frame stored (or individual pixels) stored in the frame buffer 226 to apply one or more post-processing effects based on information regarding the assigned regions and subsampling characteristics for each region of the frame, such as ambient occlusion or tone mapping, edge enhancement, edge smoothing, upscaling, machine learning-based upscaling, or super resolution. In some implementations, the post-processing circuitry 230 additionally blends transitions between adjacent subsampled regions having different subsampling characteristics prior to the frame being output to the display (e.g., based on color, frequency response of details, etc.). The post-processed frame is written to a frame buffer 226, such as a back buffer for display or an intermediate buffer for further post-processing. The example graphics pipeline 200, in some embodiments, includes other shaders or components, such as a computer shader 240, a ray tracer 242, a mesh shader 244, and the like, which are configured to communicate with one or more of the other components of example graphics pipeline 200.

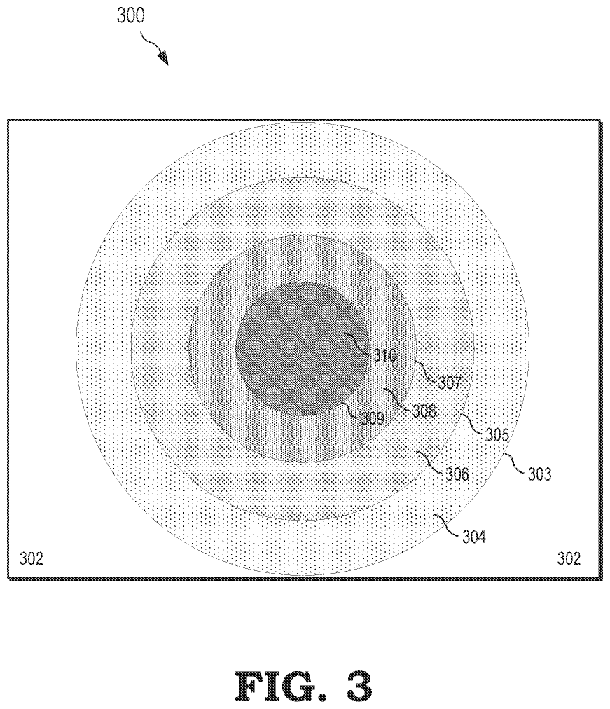

FIG. 3 is a diagram illustrating multiple regions of a frame 300 having different subsampling characteristics in accordance with some embodiments. In the illustrated example, based on gaze tracking and/or other characteristics of the frame 300, the APU 102 divides the frame 300 into regions 302, 304, 306, 308, and 310. The APU 102 assigns pixels in the region 310 to be fully rendered, as the region 310 is determined to be the foveal region at which the user's eyes are focused. The APU 102 assigns region 308, which is adjacent to region 310 and shares a border 309 with region 310, subsampling characteristics that result in the pixels of region 308 being less fully rendered than the pixels of region 310. For example, in some implementations, 25% of the pixels of region 308 are assigned to be left unrendered, in either a horizontal or vertical direction, or both. The APU 102 assigns region 306, which is adjacent to region 308 and shares a border 307 with region 308, subsampling characteristics that result in the pixels of region 306 being less fully rendered than the pixels of region 308. For example, in some implementations, 50% of the pixels of region 306 are assigned to be left unrendered, in either a horizontal or vertical direction, or both.

Similarly, the APU 102 assigns region 304, which is adjacent to region 306 and shares a border 305 with region 306, subsampling characteristics that result in the pixels of region 304 being less fully rendered than the pixels of region 306. For example, in some implementations, 75% of the pixels of region 304 are assigned to be left unrendered, in either a horizontal or vertical direction, or both. Finally, the APU 102 assigns region 302, which is adjacent to region 304 and shares a border 303 with region 304, subsampling characteristics that result in the pixels of region 302 being less fully rendered than the pixels of region 304. In the illustrated example, regions 310, 308, 306, and 304 are concentric circular rings, but in other examples, the regions may be oval or have other shapes that are not necessarily symmetrical or concentric. Region 302 fills the area between region 304 and the borders of the rectangular frame 300.

If the frame rate is sufficiently high and the user's gaze remains focused at region 310, any discontinuities between the subsampling characteristics applied to each of regions 308, 306, 304, and 302 are likely to be imperceptible to the user. However, if the user quickly shifts his or her gaze or the frame rate is insufficiently high, artifacts may be visible between regions having different subsampling characteristics. To reduce perceptual artifacts, the processing system 100 assigns one of the APU 102 and the dGPU 134 to post-process the frame 300 based on information regarding the assigned regions and the subsampling characteristics of each region.

For example, in some implementations, either the APU 102 or the dGPU 134 applies a first post-processing filter (not shown) to the region 308 or to the border 309 to perform post-processing effects such as edge enhancement, upscaling, machine learning-based upscaling, or super resolution based on the subsampling characteristics of region 308 and/or a difference in subsampling characteristics of region 308 and the fully rendered characteristics of region 310. In an example, the first post-processing filter performs upscaling or machine learning-based upscaling through which one or more upscaling algorithms are used to scale the lower resolution region 308 to a higher resolution. For example, the first post-processing filter may apply an algorithm such as nearest-neighbor, bilinear, or bicubic interpolation, which uses comparatively lower computational resources but produces lower quality (e.g., less accurate) output. Alternatively, the first post-processing filter may apply an upscaling algorithm that uses machine learning (e.g., using neural networks or other models), which will typically produce higher quality output but require substantial computational resources.

The APU 102 or the dGPU 134 applies a second post-processing filter (not shown) to the region 306 or to the border 307 between region 308 and region 306 based on the subsampling characteristics of region 306 to minimize artifacts between the different subsampling characteristics of region 308 and region 306. In some implementations, the second post-processing filter is different from the first post-processing filter. For example, in some implementations the second post-processing filter applies super-resolution techniques. Super-resolution techniques typically apply spatial interpolation and motion compensation algorithms to extract pixel information from low-resolution images for use in generating an enhanced image frame (e.g., a high-resolution image frame). In similar fashion, the APU 102 or the dGPU 134 applies a third post-processing filter (not shown) to the region 304 or to the border 305 between region 306 and region 304 based on the subsampling characteristics of region 304, and applies a fourth post-processing filter (not shown) to the region 302 or to the border 303 between region 304 and region 302 based on the subsampling characteristics of region 302. In some implementations, the APU 102 or the dGPU 134 applies more than one filter to each subsampled region or border.

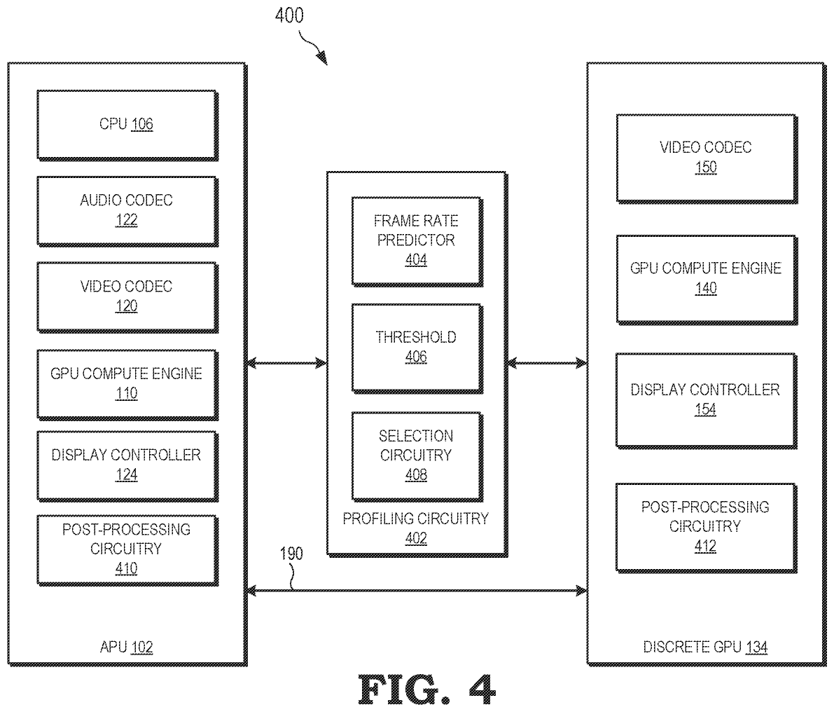

FIG. 4 is a block diagram of profiling circuitry 402 of a processing system 400 selectively tasking an accelerated processing unit 102 or a discrete graphics processing unit 134 with post-processing a foveated rendered frame in accordance with some embodiments. The example processing system 400 includes the APU 102 that integrates the CPU 106, the GPU 104, an audio codec 122 (e.g., an audio co-processor), the video codec 120, the GPU compute engine 110, the display controller 124, and post-processing circuitry 410. The dGPU 134 includes the video codec 150, the GPU compute engine 140, the display controller 154, and post-processing circuitry 412. It should be noted that each of the components of FIG. 1 can be included in the APU 102 and the dGPU 134, but those depicted in FIG. 4 are used for illustrative convenience. Similar to FIG. 1, the APU 102 communicates with the dGPU 134 over an interconnect such as a PCIe interconnect 190.

Profiling circuitry 402 adaptively distributes post-processing of frames by determining whether post-processing of a frame is to be performed at the APU 102 or at the dGPU 134 and tasking either the APU 102 or the dGPU 134 with post-processing the frame based on the determination and to determine a trade-off between scalar complexity and frame rate. In some implementations, profiling circuitry 402 tasks the dGPU 134 with post-processing the frame unless the frame rate of a video stream including the frame would be reduced by at least a threshold amount by devoting processing cycles of the dGPU 134 to post-processing the frame. To this end, in the illustrated example, profiling circuitry 402 includes a frame rate predictor 404. The frame rate predictor 404 includes circuitry or software to predict an impact on the frame rate of the dGPU 134 performing post-processing on the frame. If the predicted impact is less than a threshold 406, selection circuitry 408 of the profiling circuitry 402 selects the dGPU 134 to perform post-processing of the frame. Post-processing circuitry 412 of the dGPU 134 applies one or more post-processing filters to each of one or more subsampled regions (or borders between subsampled regions) based on the subsampling characteristics of the region.

If the predicted impact meets or exceeds the threshold 406, selection circuitry 408 of the profiling circuitry 402 selects the APU 102 to perform post-processing of the frame. Post-processing circuitry 410 of the APU 102 applies one or more post-processing filters to each of one or more subsampled regions (or borders between subsampled regions) based on the subsampling characteristics of the region. Thus, the APU 102 blends discontinuities between regions of the frame having different subsampling characteristics without impacting the processing bandwidth or frame rate of the dGPU 134.

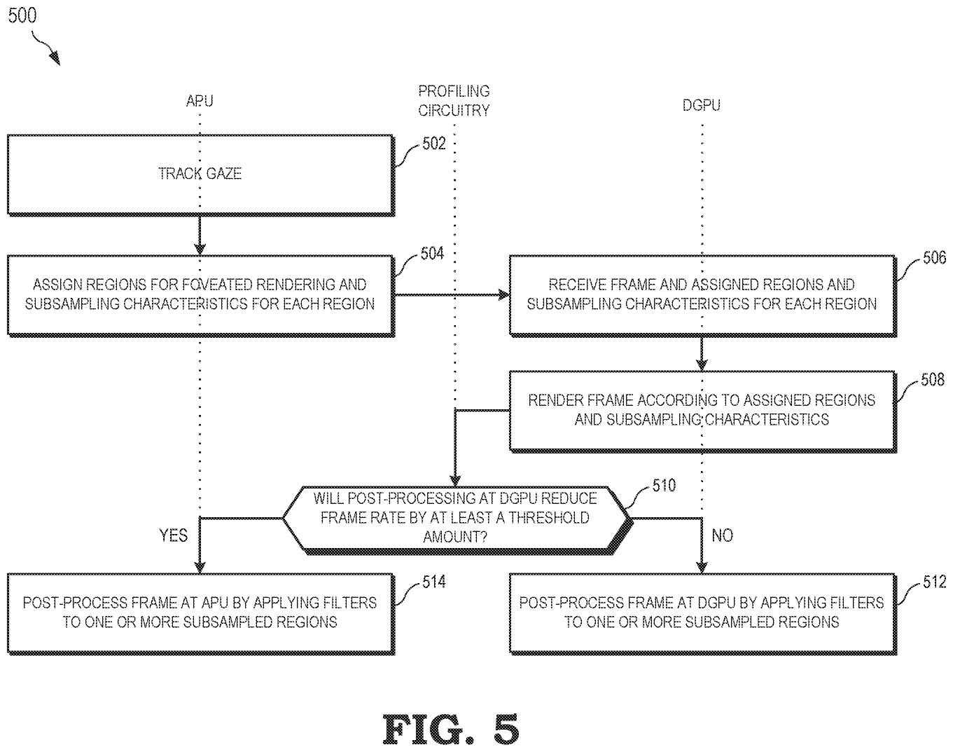

FIG. 5 is a flow diagram illustrating a method 500 for post-processing foveated rendered frames in accordance with some embodiments. In some implementations, the method 500 is performed by a processing system such as processing system 100.

At block 502, the APU 102 determines a center of gaze for each eye in real-time. In some implementations, the APU 102 receives gaze tracking information from the dGPU 134, the CPU 106, a gaze tracking sensor, or other component) and determines a foveal region of a frame at which the user's gaze is focused based on the gaze tracking information. For example, in some implementations, the APU 102 receives gaze information from a sensor from which the APU 102 derives the gaze direction. In other implementations, the dGPU 134 determines the gaze direction of the user's eyes. Thus, although tracking a gaze is illustrated as occurring at the APU 102 in the example of FIG. 5, in other implementations, tracking the gaze occurs at the dGPU 134, which then provides information regarding the gaze direction to the APU 102.

Based on the gaze direction of the user's eyes, at block 504, the APU 102 assigns regions of a frame for foveated rendering. For example, in some implementations, the APU 102 determines a foveal region at which the user's eyes are focused and one or more non-foveal regions that do not require full rendering of every pixel. The APU 102 further assigns subsampling characteristics for each non-foveal region, such as a percentage of pixels in each non-foveal region that is to remain unrendered and an orientation of unrendered pixels (e.g., every other pixel in a horizontal direction or every third pixel in a vertical direction). The APU 102 sends the frame data and information regarding the assigned regions and subsampling characteristics for each region to the dGPU 134, e.g., as metadata for the frame data.

At block 506, the dGPU 134 receives the frame data and information regarding the assigned regions and subsampling characteristics for each region. At block 508, the dGPU 134 renders the frame according to the assigned regions and subsampling characteristics for each region. The method flow then continues to block 510.

At block 510, profiling circuitry 402 determines whether post-processing at the dGPU 134 will reduce the frame rate by at least a threshold amount. If, at block 510, profiling circuitry 402 determines that post-processing the frame at the dGPU 134 will not reduce the frame rate by at least the threshold amount, the method flow continues to block 512. At block 512, post-processing circuitry 412 of the dGPU 134 post-processes the frame by applying one or more filters to each of one or more subsampled regions of the frame based on the information regarding the assigned regions and subsampling characteristics for each region. Accordingly, the dGPU 134 is able to select appropriate filters to post-process each subsampled region of the frame based on the subsampling characteristics and identification of the pixels belonging to each subsampled region.

If, at block 510, profiling circuitry 402 determines that post-processing the frame at the dGPU will reduce the frame rate by at least the threshold amount, the method flow continues to block 514. At block 514, post-processing circuitry 410 of the APU 102 post-processes the frame by applying one or more filters to each of one or more subsampled regions of the frame based on the information regarding the assigned regions and subsampling characteristics for each region. The APU 102 selects appropriate filters to post-process each subsampled region of the frame based on the subsampling characteristics and identification of the pixels belonging to each subsampled region.

In some embodiments, the apparatus and techniques described above are implemented in a system including one or more integrated circuit (IC) devices (also referred to as integrated circuit packages or microchips), such as the processing system described above with reference to FIGS. 1-5. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry”, etc.) are described or claimed as “configured” to perform one or more tasks or operations. This formulation—[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
rendering a frame comprising a plurality of regions, each region having subsampling characteristics; and
post-processing the frame based on information regarding the plurality of regions and the subsampling characteristics of each region.

2. The method of claim 1, further comprising:
rendering the frame at a discrete graphics processing unit (dGPU).

3. The method of claim 2, wherein post-processing the frame comprises post-processing the frame at an accelerated processing unit (APU) based on a frame rate of a video stream comprising the frame.

4. The method of claim 3, further comprising:
profiling an impact of performing post-processing of the frame at the dGPU on the frame rate of the video stream; and
post-processing the frame at the APU based further on the profiling.

5. The method of claim 1, wherein the plurality of regions is further based on tracking of a gaze of a viewer of the frame.

6. The method of claim 1, wherein the subsampling characteristics comprise at least one of a degree and a direction of subsampling applied to each region.

7. The method of claim 1, wherein post-processing comprises blending borders between regions of the frame having different subsampling characteristics.

8. A processing system, comprising:
a discrete graphics processing unit (dGPU) configured to render a frame comprising a plurality of regions, each region having subsampling characteristics; and
an accelerated processing unit (APU) configured to post-process the frame based on information regarding the plurality of regions and the subsampling characteristics of each region.

9. The processing system of claim 8, wherein the dGPU is further configured to render the frame with a plurality of regions having different subsampling characteristics in response to a frame rate of a video stream comprising the frame exceeding a frame rate threshold.

10. The processing system of claim 9, further comprising:
profiling circuitry configured to profile an impact of performing post-processing of the frame at the dGPU on the frame rate of the video stream.

11. The processing system of claim 10, wherein the profiling circuitry is further configured to task the APU with post-processing the frame in response to the impact exceeding a threshold.

12. The processing system of claim 8, wherein the APU is further configured to assign the plurality of regions of the frame and subsampling characteristics of each region based on tracking of a gaze of a viewer of the frame.

13. The processing system of claim 8, wherein the subsampling characteristics comprise at least one of a degree and a direction of subsampling applied to each region.

14. The processing system of claim 8, wherein the APU is configured to post-process the frame by blending borders between regions of the frame having different subsampling characteristics.

15. A processing system, comprising:
a discrete graphics processing unit (dGPU) configured to:
render a frame comprising a plurality of regions based on received information regarding the plurality of regions and subsampling characteristics of each region, the plurality of regions comprising a first region having first subsampling characteristics and a second region having second subsampling characteristics different from the first subsampling characteristics; and
post-process the frame based on the received information regarding the plurality of regions and subsampling characteristics of each region.

16. The processing system of claim 15, further comprising:
profiling circuitry configured to profile an impact of performing post-processing of the frame at the dGPU on a frame rate of a video stream comprising the frame.

17. The processing system of claim 16, further comprising:
an accelerated processing unit (APU) configured to post-process the frame based on the plurality of regions and the subsampling characteristics of each region, wherein the profiling circuitry is further configured to task the APU with post-processing the frame in response to the impact exceeding a threshold.

18. The processing system of claim 17, wherein the APU is further configured to assign the plurality of regions of the frame and subsampling characteristics of each region based on tracking of a gaze of a viewer of the frame.

19. The processing system of claim 15, wherein the subsampling characteristics comprise at least one of a degree and a direction of subsampling applied to each region.

20. The processing system of claim 15, wherein the dGPU is configured to post-process the frame by blending borders between regions of the frame having different subsampling characteristics.
